(19) United States
(12) Patent Application Publication
(10) Pub. No.: US 2024/0350338 A1
(43) Pub. Date: Oct. 24, 2024

(54) MULTI-POSITION BED FOR LONG-TERM PATIENTS

(71) Applicant: Agustin MARTÍNEZ CONTRERAS, Ciudad de Mexico (MX)

(72) Inventor: Agustin MARTÍNEZ CONTRERAS, Ciudad de Mexico (MX)

(21) Appl. No.: 18/761,376

(22) Filed: Jul. 2, 2024

Related U.S. Application Data
(63) Continuation-in-part of application No. PCT/MX2022/050064, filed on Jul. 20, 2022.

(30) Foreign Application Priority Data
Jan. 28, 2022 (MX) MX/U/2022/000042

(51) Int. Cl. A61G 7/005; A61G 5/10; A61G 7/16

(52) U.S. Cl. CPC A61G 7/005; A61G 5/104; A61G 7/165

(57) ABSTRACT

The present invention relates to a long-term bed designed to support patient recovery by offering multiple positions to make the patient's stay more comfortable. These multiple positions help reduce pressure points to prevent the formation of bedsores on the patient's skin. Additionally, the bed aids patient recovery by providing continuous leg movement exercises, which prevent the loss of mobility and the potential formation of blood clots. The bed is equipped with a touch screen that the patient can operate independently or with the help of a family member. The touch screen will feature a specific program allowing the bed to adopt the following positions: lying down with extended legs, standing with extended legs, lying down with raised legs, lying down with extended legs, continuous leg movement in the lying position, and continuous back movement from horizontal to inclined in a seated position.

### CROSS-REFERENCE TO RELATED APPLICATIONS

This application claims priority to and is a continuation in part of PCT Application No. PCT/MX2022/050064, filed on Jul. 20, 2022, which claims the benefit of the filing date of Mexican Application No. MX/u/2022/000042, filed on Jan. 28, 2022, the entirety of which is herein incorporated by reference.

### TECHNICAL FIELD

The present invention generally relates to health equipment technologies and, more particularly, to a long-term bed that supports patient recovery by presenting multiple positions to make the patient's stay more comfortable.

### BACKGROUND OF THE INVENTION

Currently, there are various hospital beds that allow a patient to activate a series of functions through a screen or touch control to adjust the backrest and legs into different positions. However, none of them have managed to make the bed take the form of a “recliner” and also be able to bring the patient from a fully reclined position to a completely vertical position without physical effort from either the patient or the caregiver.

Some patent documents and internet sources within the same technical field, i.e., hospital beds that can move into various positions, are as follows:

Chinese Patent Application No. CN 101828998 A describes a hospital bed that allows the patient to lie down, sit, and stand. The hospital bed comprises a bed support frame, a bed plate frame, and a bed plate. The bed plate consists of an upper rotating plate, a fixed plate, and a lower rotating plate. The upper rotating plate is movably fixed to the bed plate frame through the upper rotating plate axis on both sides of the bed plate frame. The lower rotating plate is movably fixed to the bed plate frame through the lower rotating plate axis on both sides of the bed plate frame. A start lever with a rotating plate is arranged on the bed plate frame by means of a rotating axis of the start lever with a rotating plate, arranged on the bed plate frame. One end of the start lever with the rotating plate supports the back of the upper rotating plate, and the other end supports the back of the lower rotating plate. The rotating axis of the bed plate frame is arranged between the bed support frame and the bed plate frame. A traction wheel is arranged on the bed support frame, and a traction rope is tied at the lower end of the lower rotating plate.

The present invention differs from Chinese Patent Application No. CN 101828998 A in that the bed, in said application, is operated through a lever that rotates a wheel, transmitting movement to a rope that moves the rest of the pieces. In contrast, the present invention is operated via a touch screen that activates the primary (9) and secondary (10) motors, which, by contracting or extending, move the rest of the components.

Another document in the same technical field is Chinese Patent Application No. CN 107374860 A, which refers to a multifunctional hospital bed for a paralyzed patient. It comprises a fixed bed frame, a movable bed frame, and a mattress. The fixed bed frame includes a support grid; the movable bed frame includes an upper-section bed frame, a middle-section bed frame, and a lower-section bed frame. The upper end and lower end of the middle section bed frame are hinged to the upper section bed frame and the lower section bed frame, respectively. Wheels are arranged below the middle section bed frame, and the movable bed frame is movably arranged on the support grid. The mattress consists of an upper-section mattress, a middle-section mattress, and a lower-section mattress. The upper end and lower end of the middle section mattress are respectively hinged to the upper section mattress and the lower section mattress. The upper surface of the movable bed frame is provided with rails, the lower surface of the mattress is provided with sliding wheels, and the mattress is arranged on the movable bed frame through the connection between the rails and the sliding wheels.

The present invention differs from Chinese Patent Application No. CN 107374860 A in that said application describes a bed with a support grid and hinges, as well as wheels and rails between the mattress and the bed frame, while the present invention uses hardware, screws, nuts, bearings, and bushings as supports and pivot points.

Chinese Patent Application No. CN 110353912 A describes a special hospital bed for heart failure patients, comprising a bed body and a cushion body. First rotary assemblies are arranged in three positions on each of the two sides of the bed body, and second rotary assemblies are arranged in three positions on each of the two sides of the cushion body. Holding boxes are fixedly connected to both sides of the front end of the bed body, and holding rods are fixedly connected to both sides of the front end of the cushion body. The holding rods and holding boxes are vertically joined and held up and down. First support rods are connected to the left and right ends of one side of the lower end of the bed body, and second support rods are fixedly connected to the left and right ends of the other side of the lower end of the bed body. Third rotary assemblies are arranged on both sides of the upper end of each second support rod. The rotation of the bed body and cushion body can be achieved through the first and second rotary assemblies, and the positions of the bed body and cushion body after rotation can be fixed through the first and second rotary assemblies.

The present invention differs from Chinese Patent Application No. CN 110353912 A in that said application describes a bed with a base and a mattress articulated by six pieces called “rotary assemblies” consisting of a holding box and a rod arranged on the sides, which move and support the bed components. In contrast, the present invention uses motors located in different parts of a fixed base for the same purposes, but the functionality of positioning the patient vertically or seated without physical effort using a touch screen offers a significant advantage to the patient.

Chinese Utility Model No. CN 204484552 U describes a nursing hospital bed integrated with a chair. It comes with a nightstand, a bed board, eight bed legs, universal wheels, and an infusion stand. The bed board comprises a first bed board body and a second bed board body, three square wooden boards connected through folding supports. The first bed board body is connected with the second bed board body through bed legs. Eight bed legs are placed on the lower surface of the bed board, and universal wheels are arranged on the bed legs at the four corners of the bed board. The bed leg mounted on the lower surface of the first square wooden board of the first bed board body can be folded through a rotating shaft. The headboard is connected to the second bed board body through a rotating shaft. The infusion stand is arranged on the bed board and connected to the bed board through a support rod. The support rod comprises two parts, a locking pin is arranged on the support rod, a transverse board is placed near the headboard position of the bed board, and a trash box and a storage box are arranged between the transverse board and the bed board.

The present invention differs from Chinese Utility Model No. CN 204484552 U in that said model describes a nursing hospital bed integrated with a chair. In contrast, the present invention is specifically designed for patients, eliminating the need for nurses to help the patient sit up. This is achieved by the bed's electric motors, which allow the patient to assume different positions through a touch screen that activates the electric motors.

Chinese Utility Model No. CN 210962734 U refers to a bed for a wheelchair that comprises a bed body and a fully reclining wheelchair body. A notch is used to combine with the fully reclining wheelchair body in an inserted mode in the middle of the end of the bed body. Sliding grooves are formed on the left and right sides of the notch. The sliding grooves extend toward the headboard along the end of the bed body. The fully reclining wheelchair body comprises a movable wheelchair frame, a cushion frame fixedly connected to the upper end of the wheelchair frame, a backrest frame hinged to one end of the cushion frame, and a leg frame hinged to the other end of the cushion frame. Protruding strips used to slide with the sliding grooves are arranged on the left and right sides of the cushion frame, respectively.

The present invention differs from Chinese Utility Model No. CN 210962734 U describes a fully reclining wheelchair mounted on a frame when needed to function as a bed. In contrast, the present invention refers to a bed with movable components that can assume different positions, such as sitting, emphasizing that the bed does not intend to be a wheelchair.

U.S. Patent Application No. US20040154097 A1 describes a cantilevered bed/chair mobile unit that, while in its bed mode, can extend from a conventional hospital bed that is thirty-six inches wide to half its width cantilevered so that a safe transfer of a patient can be affected, even by a single caregiver. After the transfer, the patient can be transported either in bed mode or in chair mode to continue patient care. The objective of this invention is achieved by a unique lifting structure providing cantilevered support for a series of three articulated platforms forming the backrest, seat, and foot sections of the bed/chair. The lift structure comprises a telescopic tower mounted vertically on one side of a rectangular wheeled base. The platforms provide patient support for the bed/chair and are operatively coupled to an E-shaped frame mounted cantilevered horizontally from the telescopic tower controlled by a screw jack associated with it. Although a screw jack is provided, it is apparent that other jacks, such as hydraulic and scissor jacks, can be employed.

The present invention differs from U.S. Patent Application No. US20040154097 A1 in that said application describes a bed that converts into a chair with a cantilever extension that broadens the bed width to facilitate patient transfer. In contrast, the present invention is not designed to facilitate patient transfer but to provide furniture that makes the recovery of a patient more comfortable in a room. It is also intended for recovering patients and will help them achieve an upright position without physical effort through a touch screen.

U.S. Patent No. U.S. Pat. No. 5,513,406 describes a modular hospital bed and a method for patient handling that allows a patient to remain in a single hospital bed from admission until discharge, thus reducing the number of surface-to-surface transfers of the patient's bed and the number of hospital beds. The method includes providing a plurality of rolling modular beds, assigning a patient to one of the modular beds upon admission to the emergency room of a hospital, providing a plurality of re-equipable modules for selective removable attachment to the modular beds, with at least one module provided from each group of patient transport modules, critical care modules, and ambulatory/rehabilitation modules. The method involves transforming the single modular bed as the patient is treated and transferred from the emergency room, treated and transferred from the surgery room, the critical care unit, and the medical/surgical unit, and finally discharged, by attaching and detaching one of the selected re-equipable modules, thus adapting the bed to the patient's needs at any time from admission to discharge.

The present invention differs from U.S. Patent Application No. U.S. Pat. No. 5,513,406 in that the said application describes a modular bed and a method for patient handling where the modular bed was designed to add gadgets and thus cover the needs of a patient from admission to discharge. In contrast, the present invention was not designed to cover all the needs of any patient within a hospital but to facilitate the recovery and stay of long-term patients.

U.S. Patent No. U.S. Pat. No. 6,336,235 B1 describes a bed, and in particular, a bed-chair hybrid that can be manipulated to a conventional bed position with a horizontal sleeping surface on which a person lies in a supine position and a sitting position with the person's feet on or adjacent to the floor and the person's head and back supported by a seat formed by the bed. More particularly, the present invention refers to a hospital bed or a patient care bed that can be converted into a chair and is configured to facilitate various activities that a caregiver can perform on a person on the bed's sleeping surface. Additionally, it specifies a patient support apparatus that includes a support and a platform. The support includes a base and a strut coupled to the base. The platform includes a seat part and a head part pivotally coupled to the seat part. The head part is pivotally coupled to the strut. The patient support apparatus further includes at least a pair of bars pivotally coupled to the support and pivotally coupled to the seat part. The pair of bars and the strut are configured to automatically coordinate the pivoting movement of the head part relative to the seat part as the seat part moves downward toward the base.

The present invention differs from U.S. Patent No. U.S. Pat. No. 6,336,235 B1 in that said patent describes a bed that can be converted into a chair, whereas the present invention does not intend to be a chair. Instead, it aims to position the patient in a seated position for activities performed on the same bed without the need to change furniture. Additionally, the described bed will provide the ability to bring the patient to a vertical position without physical effort.

In addition to the previously described patent documents, it is known that the company Paramount Bed markets the hospital bed called “VitalGo Total Lift Bed,” which is a hospital bed that, through a specific mechanism, achieves a vertical position, allowing the patient to be “standing.” This position prevents the formation of ulcers in the patient after long periods of lying down and improves circulation in the lower extremities.

The present invention differs from the hospital bed called “VitalGo Total Lift Bed” in that said hospital bed was designed to fully verticalize a patient, whereas the present invention also achieves verticalization of the patient and additionally adopts the form of a “recliner.” Furthermore, it features an automatic exercise sequence activated from a touch screen.

The previously cited patent documents and internet sources specify various types of hospital beds; however, none of them solve the technical problem of a hospital bed having positions such as fully vertical so that the patient can stand and adopting the form of a “recliner,” meaning the patient can be seated.

### BRIEF DESCRIPTION OF THE INVENTION

The main objective of the present invention is to provide a bed that is specially designed for long-term patients, offering conveniences to patients while at home to help them stand up or sit down for meals.

Another objective is that the bed provides the ability to reduce pressure points to prevent the formation of sores on the patient's back skin, which is achieved by performing different position changes, thus avoiding the patient being in a sedentary position for long periods.

An additional objective is that this type of bed can aid in the recovery of patients by providing continuous leg movement exercises, preventing the loss of mobility.

A secondary objective is the way the bed adopts various positions, which is done through a touch screen that the patient can operate themselves or with the help of a family member. The touch screen will have a specific program for the bed to adopt the following positions: lying down with extended legs, standing with extended legs, lying down with raised legs, lying down with extended legs, continuous back movement (rocking motion), and continuous leg movement in the lying position.

Additionally, this bed allows for a wheelchair-bound patient to be transferred to the bed in a fully motorized manner without physical effort from the patient or the caregiver, thus eliminating the need for cranes currently used for this purpose.

### BRIEF DESCRIPTION OF THE DRAWINGS

To complement the description being made and to help a better understanding of the characteristics of the invention, a set of figures is included as an integral part of this description. Illustratively and not restrictively, and using the same reference signs to indicate the parts and figures shown, the following is represented:

FIG. 1. Top view of the Tubular Frame.

FIG. 2. Longitudinal section of the Frame (bed base).

FIG. 3. Top view of the Mattress Base.

FIG. 4. Longitudinal section of the Bed Base and Mattress.

FIG. 5. Side view of the tubular frame.

FIG. 6. Top view of the Bed Base and Mattress Base.

FIG. 7. Longitudinal exploded view of the Bed and Base.

FIG. 8. Longitudinal section of the Bed and Base in a horizontal position. The contracted motors are indicated, as well as the necessary pivot points and radii to achieve this position.

FIG. 9. Longitudinal section of the Bed and Base in a Raised Legs position. The main contracted motors extended secondary motors, and the necessary pivot points and radii to achieve this position are indicated.

FIG. 10. Longitudinal section of the Bed and Base in a Vertical position. The fully extended main motors and fully contracted secondary motor are indicated, along with the necessary pivot point and radius to achieve this position.

FIG. 11. Longitudinal section of the Bed and Base in a Seated position. The partially extended main motors and fully extended secondary motors are indicated, along with the necessary pivot points and radii to achieve this position.

FIG. 12. Longitudinal section of the Bed and Base with the integration of the wheelchair.

FIG. 13. Rear view of the Bed and Base in a 45-degree position with the integration of motor 1 partially extended and motor 2 contracted.

FIG. 14. Rear view of the Bed and Base in a 45-degree position with the integration of motor 1 partially extended and motor 2 extended.

FIG. 15. Main window of touch screen shows the two main operations: bed movement and light.

FIG. 16. Secondary window, showing the functions: a) lying down, b) legs up, c) sitting, d) standing, e) leg exercise and rocking.

FIG. 17. Secondary window, showing the lying down function.

FIG. 18. Secondary window, showing the legs up function.

FIG. 19. Secondary window, showing the sitting function.

FIG. 20. Secondary window, showing the standing function.

FIG. 21. Secondary window, showing the leg movement function.

FIG. 22. Secondary window, showing the rocking function.

FIG. 23. Secondary window, showing the courtesy light function.

### DETAILED DESCRIPTION OF THE INVENTION

According to the background section of the invention, the problem to be solved is that the patient or sick person can fully get up from a fully reclined position with extended feet to a fully upright vertical position without the slightest effort. Additionally, it can also transform the bed into a “recliner” type.

The bed's operation depends on a series of components, each of which is essential for the system's proper functioning. Each of these components and their operation will be described below for a better understanding of the entirety of the present invention.

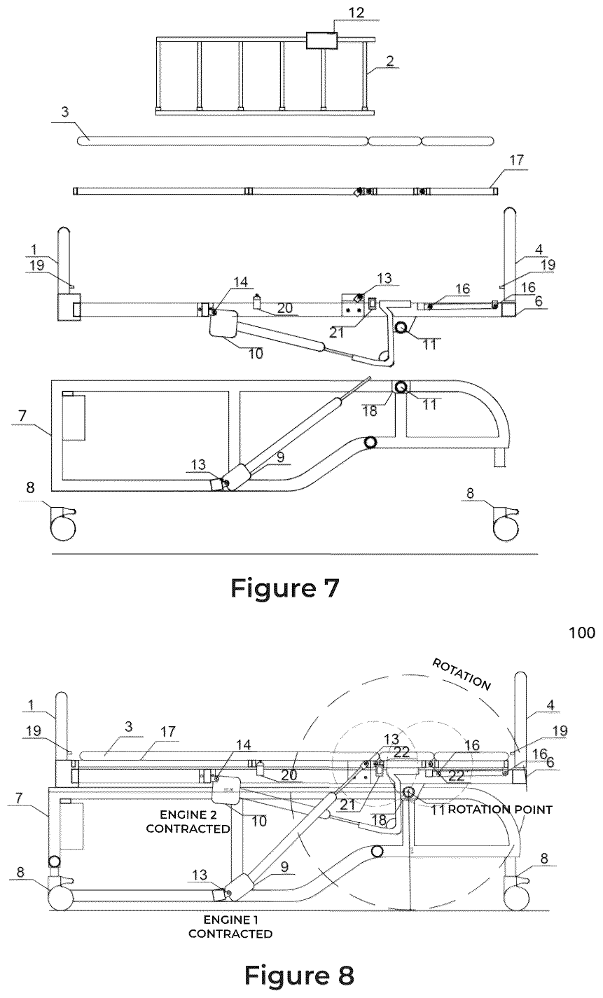

Referring now to FIGS. 7, 8, 9, 10, and 11, the bed base (6) to be protected can be observed. This piece supports the mattress base (5), which rotates on its transverse axis. The bed base (6) is mounted on the bearing holders (18), which in turn are mounted on the bed base (6), positioning it precisely at the pivot point (11) with bearing holders (18).

The bed base (6) and the mattress base (5) are joined by steel screws and nuts (not shown).

The bed base (6) is made of a 2″×1″ (5.08 cm×2.54 cm) rectangular profile, on which the following are mounted:
1. Four brackets (not shown) that serve to secure the mattress base (5) with screws and nuts.
2. Two to five brackets (13), as needed, to mount up to four main motors (9).
3. Two brackets (16) will receive the two steel flats, which act as “pivot arms” that support the mattress base (5) to place the bed in the “knees bent” position.
4. Two brackets (14) to mount up to two secondary motors (10).

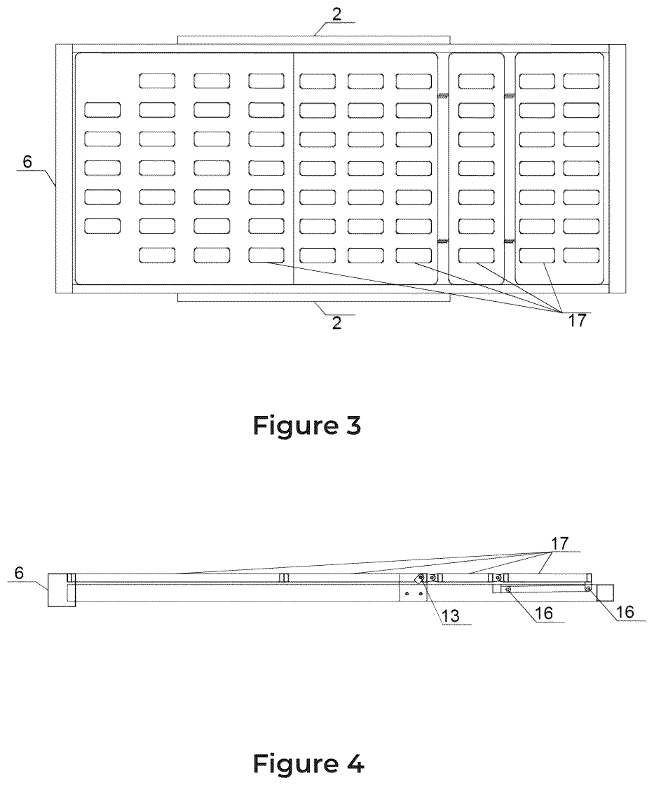

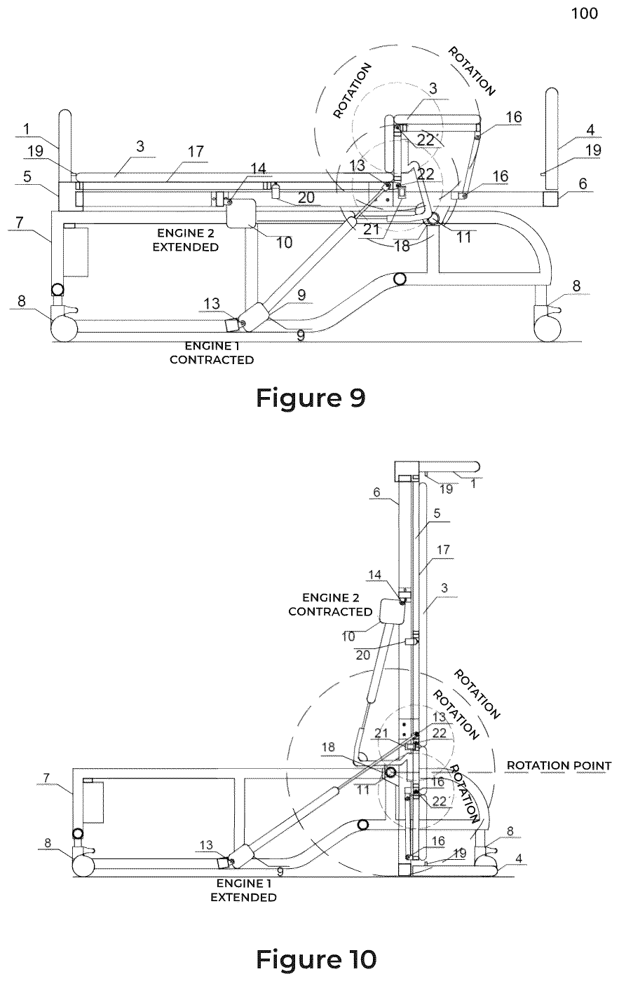

In FIGS. 3, 6, and 9, the mattress base (5) can be observed. FIG. 3 shows a top view, and FIG. 9 a longitudinal section of it. This piece provides a flat surface capable of articulating to place the patient in the “knees bent” position. It is mounted on the bed base (6) and fixed to the four brackets (not shown) that secure the mattress base (5) with nuts and screws. It is made of 3″×3″ (7.62 cm×7.62 cm) and 2½″×2½″ (6.35 cm×6.35 cm) rectangular profiles. Additionally, the mattress base (5) has four perforated steel sheet panels (17) reinforced around their perimeter with 1″×1″ (2.54 cm×2.54 cm) square steel profiles. These panels are joined with brackets and bushings, allowing several pivot points. The main pivot point is achieved with a bearing and the secondary pivot points (22 and 22′) with bushings (not shown).

This piece also comprises:
1. Two foldable guardrails (2).
2. Two brackets (14) welded to 1″×1″ (2.54 cm×2.54 cm) square profiles that serve to mount the secondary motors (10) with bushings (not shown).
3. An auxiliary structure to support the footboard (4) of the bed (100) and the patient when in a vertical position.

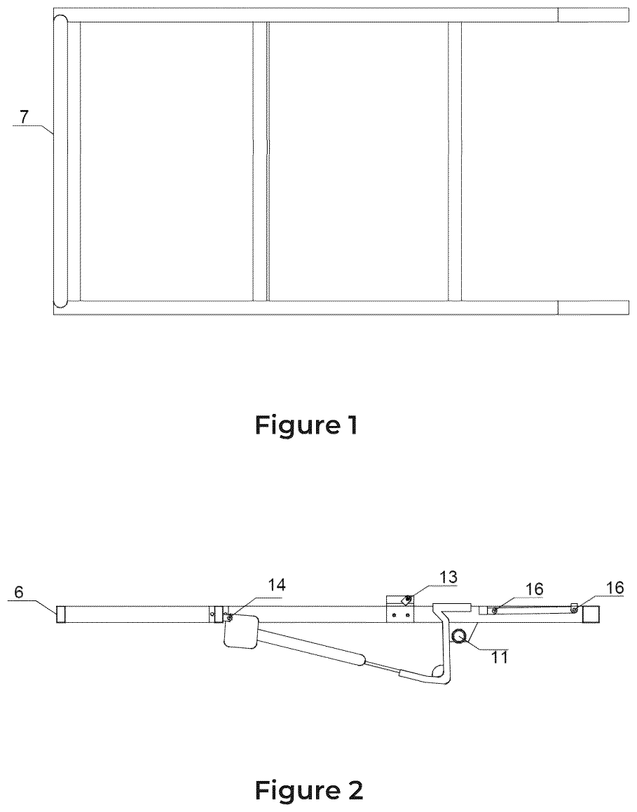

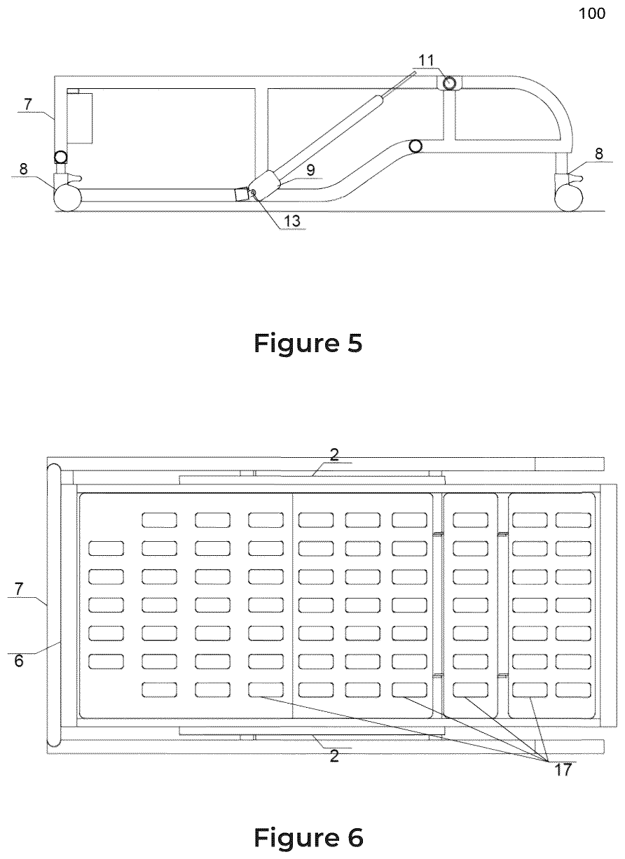

FIGS. 1, 5, 8, and 9 refer to the top view and the longitudinal section of the tubular frame (7) of the bed (100). It is the main support of the entire bed (100). This piece can only be moved manually with the help of the four steel and rubber wheels (8) it has mounted, each containing individual brakes. It is mainly made of 1¾″ (4.445 cm) galvanized steel tubular profiles and additionally reinforced transversely with 2″×2″ (5.08 cm×5.08 cm) square steel profiles.

The tubular frame (7) has various additional profiles that serve to support the rest of the bed (100):
1. A ½″ (1.27 cm) tubular profile support (not shown) at the main pivot point (11) on which a bearing holder (18) is mounted, and on which the bed base (6) pivots.
2. A 2″×2″ (5.08 cm×5.08 cm) square steel profile (not shown) on which five brackets (13) are welded to support up to six motors (main and secondary). These motors can have different power levels. In the case of the main motors (9), the load capacity ranges from 100 to 125 kg per motor with a 34 cm arm displacement to achieve fully vertical and horizontal positions. For the secondary motors (10), the push capacity ranges from 60 to 80 kg with a 28 cm stroke to support the various weights of the patients or sick people using this device. The brackets (13) of the square steel profile serve to mount the main motors, which are represented in FIGS. 9 and 10.
3. Four tubular profiles (FIG. 7) to mount the wheels (8) through the integrated shafts.
4. Two 2″×2″ (5.08 cm×5.08 cm) square steel profiles (not shown) that act as stops to halt the frame (6) when fully verticalizing the patient in the “standing” position.

FIG. 6 shows a top view of the bed mounted on its base.

FIG. 7 shows a longitudinal exploded view that indicates each component of the bed (100) in an exploded model: headboard (1), foldable and maneuverable guardrail (2) for user convenience, mattress sectioned into 3 parts for better articulation (3), footboard (4), mattress base (5), bed base (6), tubular frame (7), bed wheels (8), main motors' trajectory (9), secondary motors (10), main pivot point (11) with bearing, secondary pivot points (22 and 22′) with bushings, touch screen (12), main motors' brackets (13), secondary motors' brackets (14), mounting brackets (not shown), pivot arms' brackets (16), perforated sheet panels (17), bearing holder (18), and stop buttons (19).

The multi-position bed (100) for long-term patients in question features an electromechanical touch activation system comprising primarily three motors (up to six possible motors) according to the patient's weight capacity: two main motors (9), expandable up to four, and up to two secondary motors (10), with four pivot points: two main pivot points (11) and two secondary pivot points (22 and 22′), strategically located to facilitate the adoption of various positions. The operation of this mechanism is described in detail below:

There are two main components, the first being the main motors (9) labeled as motor 1 and motor 2, compared to the secondary motor (10), labeled as motor 3. The motors are numbered as follows:
1. Motor 1 (left piston): Located on the left side of the bed, it controls the contraction and extension of the piston on the left side of the bed simultaneously with the help of motor 2.
2. Motor 2 (right piston): Located on the right side of the bed, it controls the contraction and extension of the piston on the right side of the bed simultaneously with the help of motor 1.
3. Motor 3 (central piston): Positioned in the central area below the bed base (6) structure, it governs the seat articulation.

Additionally, there are various pivot points (11, 22, and 22′) located on the bed base (6), which are divided into two:
1. Main pivot points (11), of which there are two: located on the left and right sides of the bed and adjacent to the bearing holder (18), allowing the bed to tilt between horizontal and vertical positions.
2. First additional pivot point (22): Integrated on both sides at the top of the seat, adjacent to the backrest, facilitating the bed to generate a seated position.
3. Second additional pivot point (22′): Integrated on both sides at the bottom of the seat, adjacent to the upper end of the footboard, further contributing to the bed generating a seated position, achieving knee flexion.

### Verticalization and Horizontalization of the Bed

The main motors (1) work synchronously, pushing in parallel to verticalize and horizontalize patients of different weights.

### Articulation Between the Backrest and Seat:

Motor 3, through the connection to an “S”-shaped tube, controls the seat articulation. When Motor 3 retracts the piston, the “S”-shaped tube retracts accordingly, causing the additional pivot points to rotate the seat to align with the backrest, achieving a perfectly horizontal and stretched position. Conversely, the extension of the piston by Motor 3 pushes the “S”-shaped tube, causing the additional pivot points (22 and 22′) to rotate, tilting the seat to achieve the desired seated position.

### Specific Movements:

### Reclined/Sitting Position:

Starting from a horizontal position where the patient is completely lying down, the extension of the secondary motor (10) is activated, raising the legs to 90 degrees to adopt a knees-bent position. Subsequently, the main motors (9) are simultaneously activated to verticalize the bed to the desired 45-degree position, so the patient is in a seated position.

### Leg Movement:

From the seated position, the main motors (9) retract to return the bed to the completely horizontal position. Additionally, the secondary motor (10) is programmed to perform a cycle of piston retraction and extension, generating continuous rotation of the additional pivot points (22 and 22′) and leg movement in a loop.

From the lying position, the secondary motor (10) cyclically extends and contracts to perform a loop of leg contraction and extension “without effort for the patient” from the repetitive movement of piston 3.

The electromechanical actuation system of the patient bed, composed of three motors and strategically located pivot points, allows for a wide range of movements and positions to provide comfort and facilitate patient care. The system's design ensures smooth, precise, and safe operation.

### Rocking Function

In FIG. 9, which represents the longitudinal section of the bed mounted in the “knees-bent” position, the bed's rocking function is specified. In this position, the mattress base (5) and the bed base (6) are at 0° relative to the floor, and two of the four sheet panels (17) are bent at 90° to each other. The necessary pivot points and radii for achieving this position are indicated, as well as the contracted secondary motors (10), which are used to bend the mattress base (5) and consequently lift the patient's legs. These motors consist of an electric motor driving a “worm” type reducer, which in turn extends or retracts a linear actuator (depending on the provided voltage polarity).

The number of secondary motors (10) in the bed will vary depending on the type of patient for whom it is designed, requiring up to two motors based on the weight they need to move. The motors are supported on brackets (14) welded to the mattress base (5), bed base (6), and tubular frame (7).

In addition, the main pivot point (11) allows for an upward rotation of the bed backrest by activating the main motors (9) and keeping the secondary motor (10) contracted, gradually bringing the patient to a seated position and then laying them back down. This movement is performed in continuous cycles to allow the patient to continuously and gradually change position, fulfilling the function of behaving like a “rocking chair.”

Integration with Wheelchair

FIG. 10 shows the longitudinal section of the bed mounted in a vertical position, displaying its integration with a wheelchair. In this position, the mattress base (5) and the bed base (6) are at 90° relative to the floor, and the sheet panels (17) are also at 90°. This figure indicates the necessary pivot points and radii to achieve the vertical position, as well as the main motors (9) which are fully extended. These main motors (9) are used to verticalize the mattress base (5). The main motor (9) drives a reducer, which in turn extends or retracts a linear actuator.

Through interaction with the touch screen (12), the bed adjusts to a fully vertical position at 90 degrees.

A sliding sheet (not shown) is used to allow the patient to lie comfortably for subsequent positioning. The guardrails (2) are then retracted, and two cushions are removed from the mattress (3) from the lumbar area to the feet, providing complete access to the wheelchair.

The guardrails (2) are then raised again, and through the touch screen (12), a first stop motion is executed, leaving the bed in a 60-degree position, followed by a second stop motion at 45 degrees. This allows for the placement of a pillow to provide a more comfortable position for the patient during the descent process, after which the bed returns to a completely horizontal position. The guardrails are lowered again, first removing the patient's safety belt and then the belts attached to the wheelchair's chassis tubes.

With the sliding sheet and the patient lying down, a movement is made toward the headboard to position the patient so that the wheelchair can be removed. The cushions are then restored to the lower part of the bed, the guardrails (2) are returned to their original position, and finally, the sliding sheet is removed. This describes a method and system for facilitating a seamless, safe, and efficient transition of a patient between a bed and a wheelchair, optimizing the transfer process and ensuring patient comfort and safety.

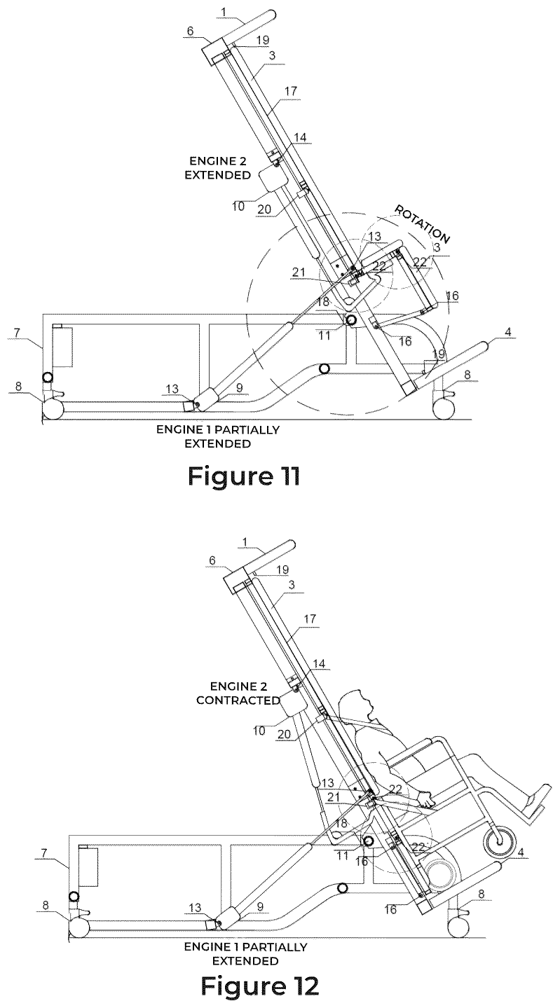

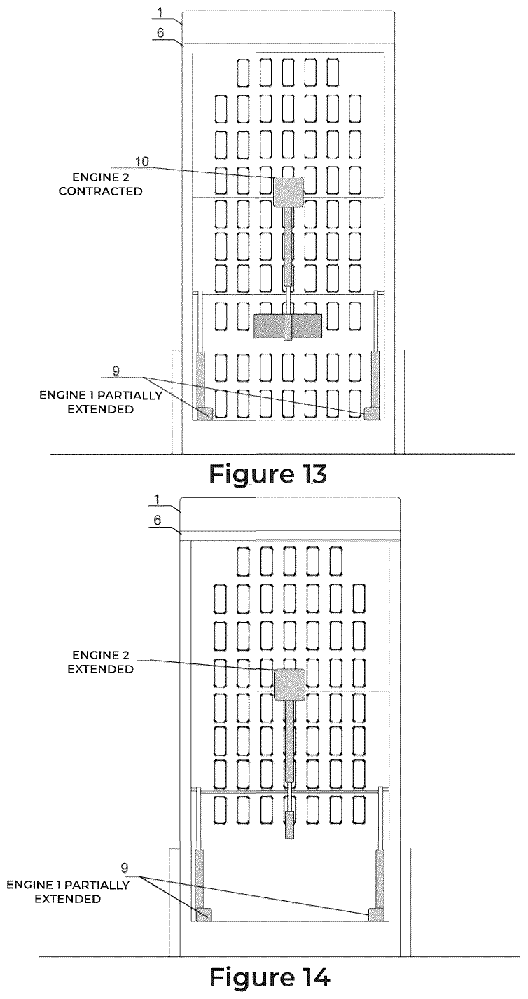

It should be noted that the wheelchair that can fit into the bed, as shown in FIG. 12 of the present invention, has the following characteristics:

The wheelchair is a commercial chair with standard measurements, and the only difference from traditional chairs is that this one has four wheels of the same size.

The wheelchair has four wheels of the same diameter to parallelly fit with the mattress base. Additionally, it has a partially reclining backrest, preventing the handles from interfering with the operation when positioning the patient on the bed.

It is worth mentioning that this chair is a conventional folding chair.

FIG. 11 refers to a longitudinal section of the bed mounted on its base, in a seated position. In this position, the mattress base (5) and the bed base (6) are at 75° relative to the floor. The main motors (9) are shown partially extended, and the secondary motors (10) are shown contracted. The necessary pivot points and radii to achieve this position are also indicated.

FIG. 8 refers to a longitudinal section of the bed mounted in a completely horizontal position. In this position, the mattress base (5) and the bed base (6) are at 0° relative to the floor, and the sheet panels (17) are also at 0°. The main motors (9) are shown contracted, and the secondary motors (10) are also shown fully contracted.

Additionally, the bed (100) incorporates an improved safety and movement control system. The bed (100) is equipped with two or four stop buttons (19) strategically located on the left and right sides when facing the patient, two at the footboard (4), and another two at the headboard (1). These stop buttons (19) allow the user to instantly and efficiently stop all bed movement activity to prevent any kind of failure by interacting with the main motors (9). The ergonomic design of the stop buttons (19) facilitates comfortable and quick access for medical staff and caregivers, ensuring an immediate response in critical situations.

The implementation of this safety feature helps prevent accidents and enhances patient care and comfort, making this bed an advanced and reliable option in healthcare settings.

The main motor (9) can be present from 2 to 4 units, depending on the person's weight, and the secondary motor (10) can be present from 1 to 2 units.

### Integration of the Bedpan

This innovative patient bed features additional functionality that provides a comprehensive solution for medical assistance and patient comfort, allowing the patient to be placed in the legs-up position. Specifically, the bed has the unique capability to remove a cushion from the upper leg area when in a horizontal 0° position.

In this position, the cushion (3) is removed to be replaced by a conventional bedpan. Once the bedpan is placed, the patient is moved to the “seated” position, allowing healthcare personnel to provide more efficient medical assistance. The bedpan is removed by lying the patient down again to facilitate cleaning and extraction. The cushion removal function has been designed with ergonomics and accessibility in mind, ensuring the process is simple and hassle-free.

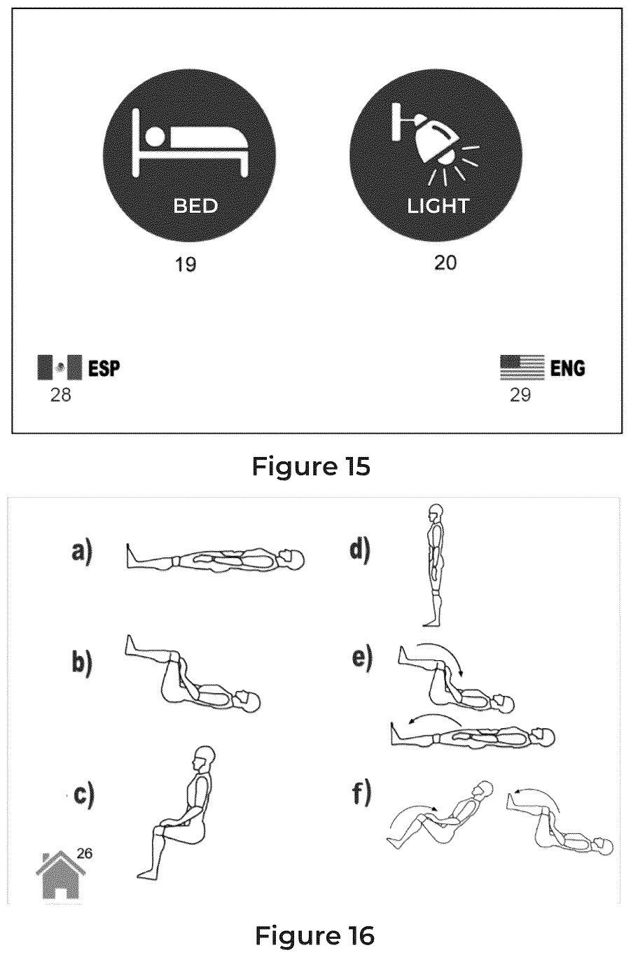

FIG. 15 shows the main window of the touch screen (12). Through the touch screen (12) and a computer program, it communicates with the entire bed system. The touch screen (12) is 7 inches (17.78 cm) and provides bidirectional communication through the icons displayed in the main window. These icons include a bed icon (19), a light icon (20), and language icons: Spanish (28) and English (29), which will give “input” and “output” data to the complete system, as well as operating instructions to the motors and lights for patient service, through communication interfaces. There is only one Courtesy Light (g).

This touch screen (12) is connected to a specific-purpose processor, such as a Raspberry Pi or its equivalent, housing an application based on the Python programming language or equivalents, specifically designed for this purpose. It sends and receives information from various components, which communicate to perform the functions described in the second window after selecting the bed icon, displaying the following functions:
Lying down
Legs up
Sitting
Standing
Leg exercise
Rocking chair

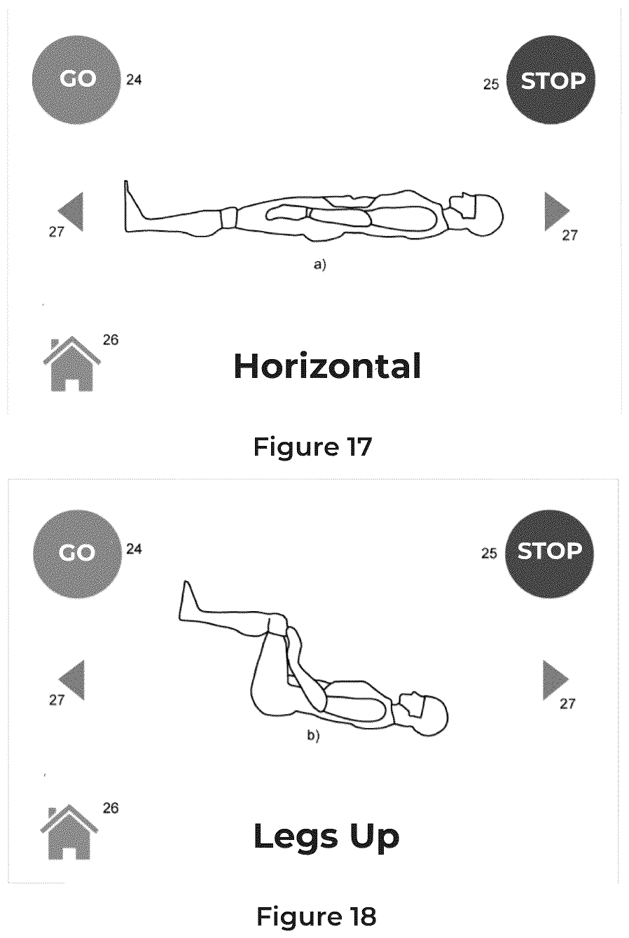

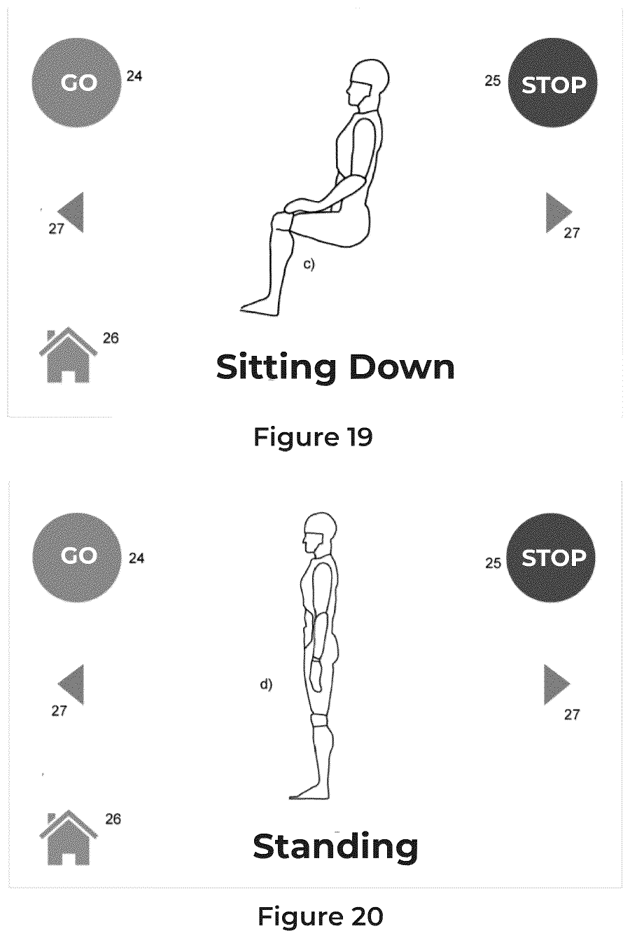

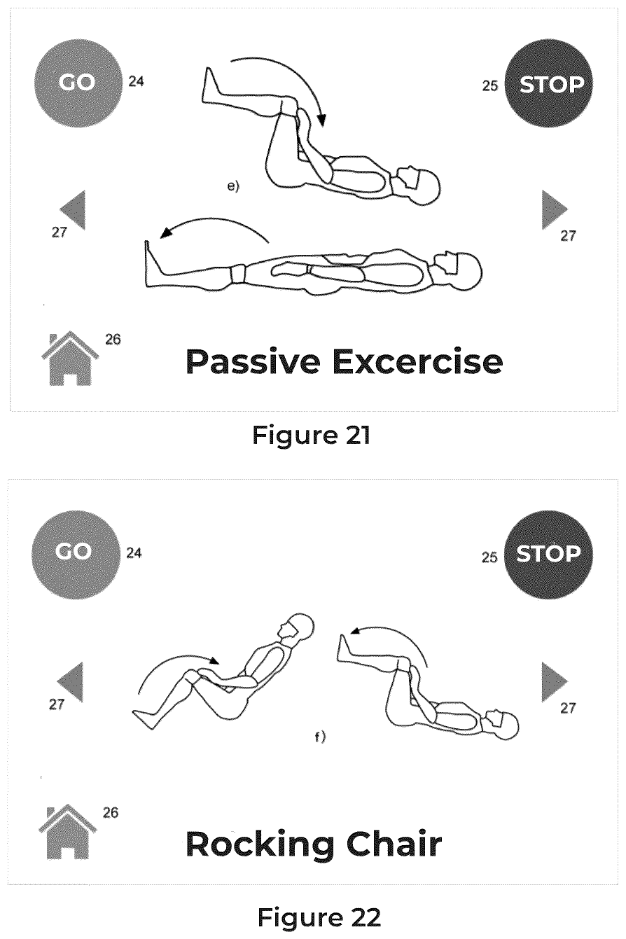

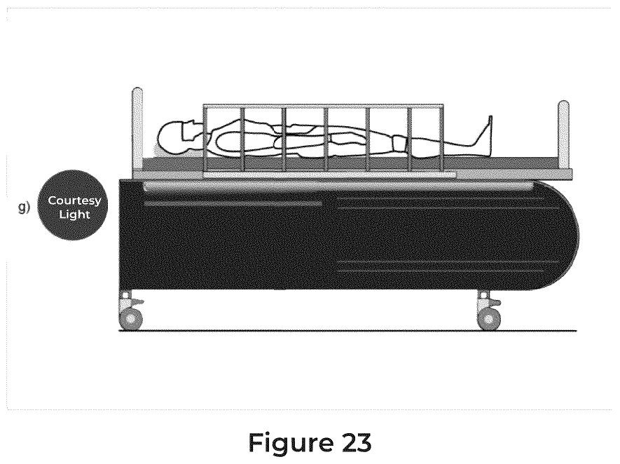

Upon selecting one of the predefined positions shown in FIG. 16, the corresponding windows will be displayed, as seen in FIGS. 17 to 22. These figures show 4 buttons: a start icon (24), a stop icon (25), a main menu icon (26) shown with a house icon, and two arrows (27) that can be clicked to proceed directly to the next function or go back if necessary.

What is claimed is:

1. A multi-position bed comprising a frame that supports the base of a mattress which can rotate on its transverse axis, wherein:
The bed base is mounted on a bearing holder, which in turn is mounted on a tubular frame, positioning the bed base precisely at the pivot point with a bearing; said bed base features rectangular profiles on which four brackets are mounted to secure the mattress base with screws and nuts;
Two steel brackets act as pivot arms, providing support to the mattress base to place the bed in a knees-bent position; and two brackets for mounting up to two secondary motors;
The mattress base is a flat surface capable of articulating to place a patient in a knees-bent position, mounted on the bed base and secured to the four brackets with screws, and additionally, the mattress base features rectangular profiles;
Additionally, the mattress base features four steel sheet panels reinforced around their perimeter with square steel profiles, joined by bushings that provide two secondary pivot points, allowing the acquisition of bent leg or seated positions;
A bed base composed of rectangular steel profiles, on which a bearing holder is mounted and rotates on the tubular frame, a square steel profile on which brackets are welded to support up to four main motors, four tubular profiles for mounting wheels through integrated shafts, and two square steel profiles that act as stops to halt the bed base when verticalizing the patient to the standing position.

2. The multi-position bed according to claim 1, wherein the entire assembly of elements comprising the bed base, tubular frame, steel sheet panels, and mattress base has a main pivot point that uses bearings to verticalize the patient and move them to the standing or lying position.

3. The multi-position bed according to claim 1, wherein the tubular frame is the main support for the entire bed, featuring galvanized steel tubular profiles where the bed base rests to support the rest of the mattress base: a rectangular profile support where the “pivot point” is located and on which a bearing holder is mounted, where the frame “rotates”; a square steel profile on which four brackets are welded to support up to four main motors; four tubular profiles for mounting wheels through integrated shafts; and two square steel profiles that act as stops to halt the frame when the patient is fully verticalized in the “Standing” position.

4. The multi-position bed according to claim 1, wherein the touch screen provides bidirectional communication through the icons displayed in the main window, including bed, light, and languages: Spanish and English, which will provide “input” and “output” data to the complete system, as well as operating instructions to the motors and lights for patient service, through bidirectional communication interfaces.

5. A multi-position bed for long-term patients, comprising an electromechanical touch system that activates two main motors and one secondary motor, four pivot points, including two primary pivot points and two secondary pivot points, located on both sides of the seat to facilitate the adoption of various positions.

6. The multi-position bed according to claim 5, wherein the main motors control the verticalization or horizontalization of the patient in a motorized manner without any additional assistance.

7. The multi-position bed according to claim 5, wherein the secondary pivot points facilitate the recline and flexion of the seat together with the secondary motor.

8. The multi-position bed according to claim 5, wherein the primary pivot points allow the bed to tilt between horizontal and vertical positions.

9. The multi-position bed according to claim 5, wherein the secondary pivot points generate the seated position together with the secondary motor.

10. The multi-position bed according to claim 5, wherein further activates the secondary motor to generate a leg movement loop through the rotation of the secondary pivot points.

11. The multi-position bed according to claim 5, wherein further activates the main motors to generate a cyclical verticalization and horizontalization movement through the rotation of the main pivot point to achieve the rocking chair function.

12. The multi-position bed according to claim 5, wherein a wheelchair coupling can be positioned parallel to the mattress base.
